(19) United States
(12) Patent Application Publication
(10) Pub. No.: US 2018/0281660 A1
(43) Pub. Date: Oct. 4, 2018

(54) AXLE STRAP WITH MAGNET SLEEVE

(71) Applicant: Ariens Company, Brillion, WI (US)

(72) Inventor: Frederick R. Dahlin, Columbia, MD (US)

(21) Appl. No.: 15/472,692

(22) Filed: Mar. 29, 2017

(51) Int. Cl. B60P 7/08; F16B 1/00; B60P 3/075; B66C 1/18

(52) U.S. Cl. CPC B60P 7/0823; F16B 1/00; F16B 2001/0035; B66C 1/18; B60P 3/075

(57) ABSTRACT

An axle strap assembly including a strap formed in loops at opposite ends around a portion of an end piece. Magnets are provided within magnet sleeves at the ends. The magnets attract each other to hold the end pieces together while being secured to an axle-securing device. The magnet sleeves hold the magnets in place during use.

### BACKGROUND

The present invention relates to an axle strap with magnets on the end pieces to hold the end pieces together while the axle strap is being secured.

### SUMMARY

In one embodiment, the invention provides an axle strap assembly comprising: an end piece; a strap folded over a portion of the end piece; a magnet; a sleeve surrounding the magnet and folded over the end piece; a loop-securing mechanism securing the sleeve to the end piece and trapping the magnet in the sleeve.

In other embodiments, the end piece is a first end piece at a first end of the strap, the assembly further comprising a second end piece at a second end of the strap, the first and second end pieces being magnetically attracted to each other. The magnet, sleeve, and loop-securing mechanism may be a respective first magnet, first sleeve, and first loop-securing mechanism; the assembly may further comprise a second magnet, a second sleeve, and a second loop-securing mechanism; the second magnet may be within the second sleeve; and the second loop-securing mechanism may be secure the second sleeve to the second end piece and trap the second magnet in the second sleeve. In other embodiments, the strap and sleeve are folded over the same portion of the end piece in overlapping fashion. In other embodiments, the strap is folded over the sleeve on the end piece. In other embodiments, the sleeve is folded over at least a portion of the strap on the end piece. In other embodiments, the loop-securing mechanism secures both the sleeve and the strap to the end piece. In other embodiments, the loop-securing mechanism includes stitching. The axle strap assembly may also include a sealing structure applied to the sleeve to capture the magnet within the sleeve, the sealing structure being separate from the loop-securing mechanism.

In another embodiment, the invention provides an axle strap assembly comprising: a first end piece having a strap-attaching portion and an axle-securing portion; a second end piece having a strap-attaching portion and an axle-securing portion; a strap defining a first strap loop folded over the strap-attaching portion of the first end piece and a second strap loop folded over the strap-attaching portion of the second end piece; a first sleeve having an interior space and defining a first sleeve loop folded over the strap-attaching portion of the first end piece; a second sleeve having an interior space and defining a second sleeve loop folded over the strap-attaching portion of the second end piece; a first magnet within the interior space of the first sleeve; a second magnet within the interior space of the second sleeve; a first loop-securing mechanism closing the first strap loop and the first sleeve loop over the strap-attaching portion of the first end piece to secure the strap to the first end piece and to trap the first magnet within the interior space of the first sleeve; and a second loop-securing mechanism closing the second strap loop and the second sleeve loop over the strap-attaching portion of the second end piece to secure the strap to the second end piece and to trap the second magnet within the interior space of the second sleeve; wherein the first and second magnets attract each other to align the axle-securing portions of the first and second end pieces to facilitate attachment of an axle-securing device to the first and second end pieces.

In some embodiments, the first and second end pieces are delta rings. In other embodiments, axle-attaching portions of the first and second end pieces are configured to receive a hook type axle-securing device. In other embodiments, the first and second sleeve loops are within the respective first and second strap loops. In other embodiments, the first and second strap loops are within the respective first and second sleeve loops. The axle strap assembly may further comprise: a third magnet within the interior space of the first sleeve, the third magnet being secured on a side of the first end piece opposite the first magnet and trapped in the interior space of the first sleeve by the first loop-securing mechanism; and a fourth magnet within the interior space of the second sleeve, the fourth magnet being secured on a side of the second end piece opposite the second magnet and trapped in the interior space of the second sleeve by the second loop-securing mechanism; wherein the third and fourth magnets attract each other to align the axle-securing portions of the first and second end pieces to facilitate attachment of an axle-securing device to the first and second end pieces. In other embodiments, the first loop-securing mechanism includes stitching. The stitching may extend through both the first strap loop and the first sleeve loop such that the first strap loop and first sleeve looped are stitched closed while simultaneously being stitched to each other. In other embodiments, the first magnet is trapped adjacent the strap-attaching portion of the first end piece and the second magnet is trapped adjacent the strap-attaching portion of the second end piece. The axle strap assembly may also include a first sealing structure applied to the first sleeve to capture the first magnet within the first sleeve; and a second sealing structure applied to the second sleeve to capture the second magnet within the second sleeve; the first and second sealing structures being separate from the first and second loop-securing mechanisms.

In another embodiment, the invention provides a method of assembling an axle strap assembly having a strap, an end piece, a magnet sleeve, and a magnet, the method comprising: inserting the magnet into the magnet sleeve; folding the magnet sleeve over the end piece; folding the strap over the end piece; and applying a loop-securing mechanism to the magnet sleeve to secure the magnet sleeve to the end piece and capture the magnet in the magnet sleeve.

In some embodiments, the end piece is a first end piece at a first end of the strap, and the method further comprises: providing a second end piece that is magnetically attracted to the first end piece; and folding the strap over the second end piece at a second end of the strap. In other embodiments, the magnet, sleeve, and loop-securing mechanism are a respective first magnet, first sleeve, and first loop-securing mechanism; and the method further comprises: inserting a second magnet into a second magnet sleeve; folding a second magnet sleeve over the second end piece; folding the strap over the second end piece; and applying a second loop-securing mechanism to the second magnet sleeve to secure the second magnet sleeve to the second end piece and capture the second magnet in the second magnet sleeve. In other embodiments, folding the strap and folding the sleeve are done in overlapping fashion. In other embodiments, applying a loop-securing mechanism includes securing both the sleeve and the strap to the end piece. In other embodiments, applying a loop-securing mechanism includes stitching the sleeve. The method may also include applying a sealing structure, independent of the loop-securing mechanism, to the sleeve to capture the magnet within the sleeve.

Other aspects of the invention will become apparent by consideration of the detailed description and accompanying drawings.

### BRIEF DESCRIPTION OF THE DRAWINGS

FIG. 1 is a perspective view of an axle strap assembly according to the present invention.

FIG. 2 is a cross-sectional view along line 2-2 in FIG. 1.

FIG. 3 is a cross-sectional view along line 3-3 in FIG. 1.

FIG. 4 is a perspective view of a magnet sleeve and magnets during assembly of the axle strap assembly.

FIG. 5 is another perspective view of the magnet sleeve and magnets during assembly.

FIG. 6 is a perspective view of the magnet sleeve being applied to an end piece during assembly.

FIG. 7 is a perspective view of the axle strap being applied over the magnet sleeve on the end piece during assembly.

FIG. 8 is an alternative configuration in which the magnet sleeve is applied over the axle strap on the end piece.

FIG. 9 is a perspective view of the axle strap assembly being installed on an axle.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

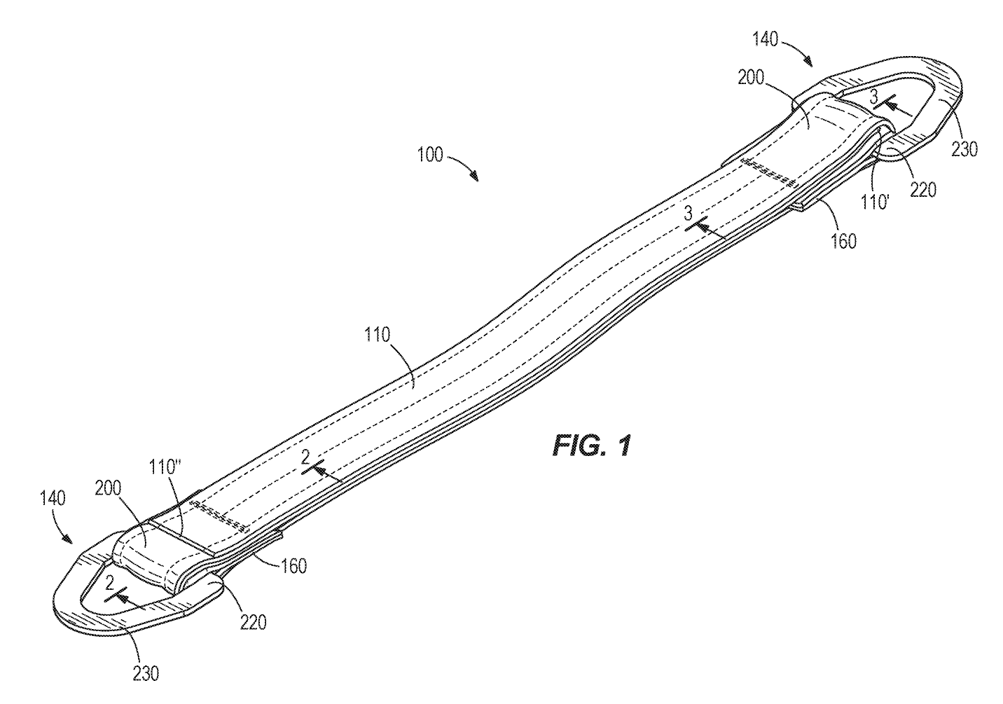

FIG. 1 illustrates an axle strap assembly 100 according to the present invention. The axle strap assembly 100 is an improved version of the axle strap disclosed in currently-pending and commonly-assigned U.S. patent application Ser. No. 15/090,514 filed Apr. 4, 2016, the entire contents of which are incorporated into this disclosure by reference. The present axle strap assembly 100 is improved primarily in the way that the magnets are captured and held in place on each of the end pieces, as will be described in more detail below.

As seen in FIGS. 1-3, the axle strap assembly 100 includes a strap 110, a pair of end pieces 140 a pair of magnet sleeves 160, and four magnets 180 (i.e., permanent magnets). In the illustrated embodiment, the strap 110 is a flat woven high-strength, flexible material such as multi-ply nylon or polyester fabric having a working load limit of at least about 3,000 lbs. The strap material includes a first end 110′ positioned adjacent one of the end pieces 140 and a second end 110″ adjacent the other end piece 140. The strap material is folded or looped over a portion of both of the end pieces 140, resulting in the strap 110 having three layers and an end piece 140 at both ends. In this regard, the ends of the strap 110 are distinguished from the ends 110′, 110″ of the strap material. The strap 110 includes a strap loop 200 at each end for engaging the end pieces 140, and in this regard, for the purposes of this disclosure, the “ends” of the strap 110 are the strap loops 200.

The end pieces 140 are generally D-shaped and are sometimes in the art referred to as delta rings. Each end piece 140 includes a strap-attaching portion 220 and an axle-securing portion 230. The strap-attaching portion 220 is the portion over which the strap loop 200 is folded or looped. In the illustrated embodiment, the strap-attaching portions 220 are the straight portion of the D-shape. The axle-securing portion 230 of each end piece 140 is the portion to which an axle-securing device is connected. An axle-securing device might be a winch for hoisting the automobile onto a tow truck or a tie-down strap to secure the automobile on the bed of a tow truck. The axle-securing device may have, for example, a hook-type connector that extends through the aligned axle-securing portions 230 of the end pieces 140. In the illustrated embodiment, the axle-securing portion 230 of each end piece 140 is the curved portion of the D-shape.

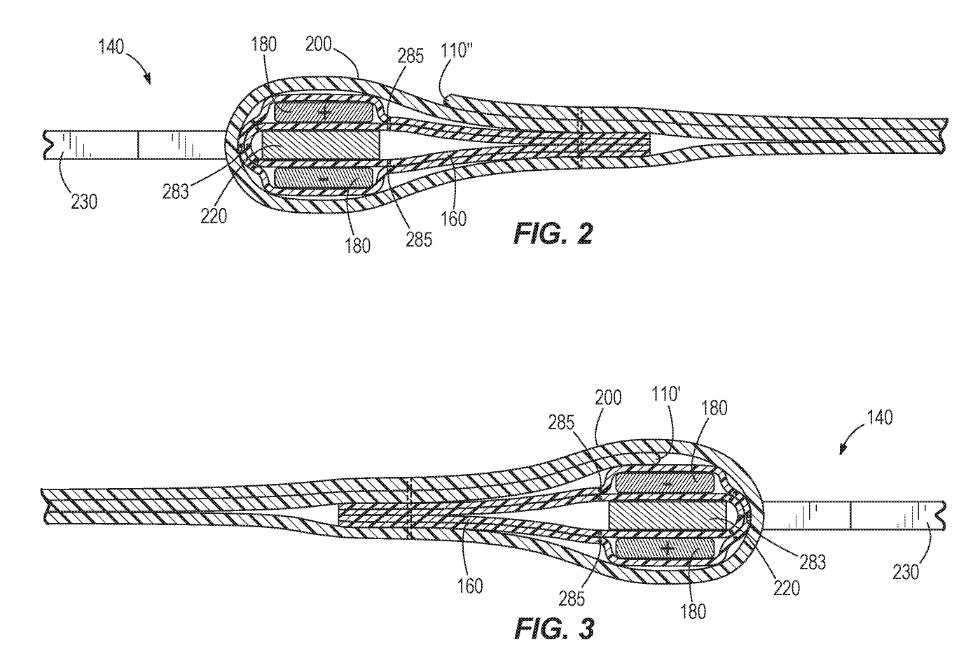

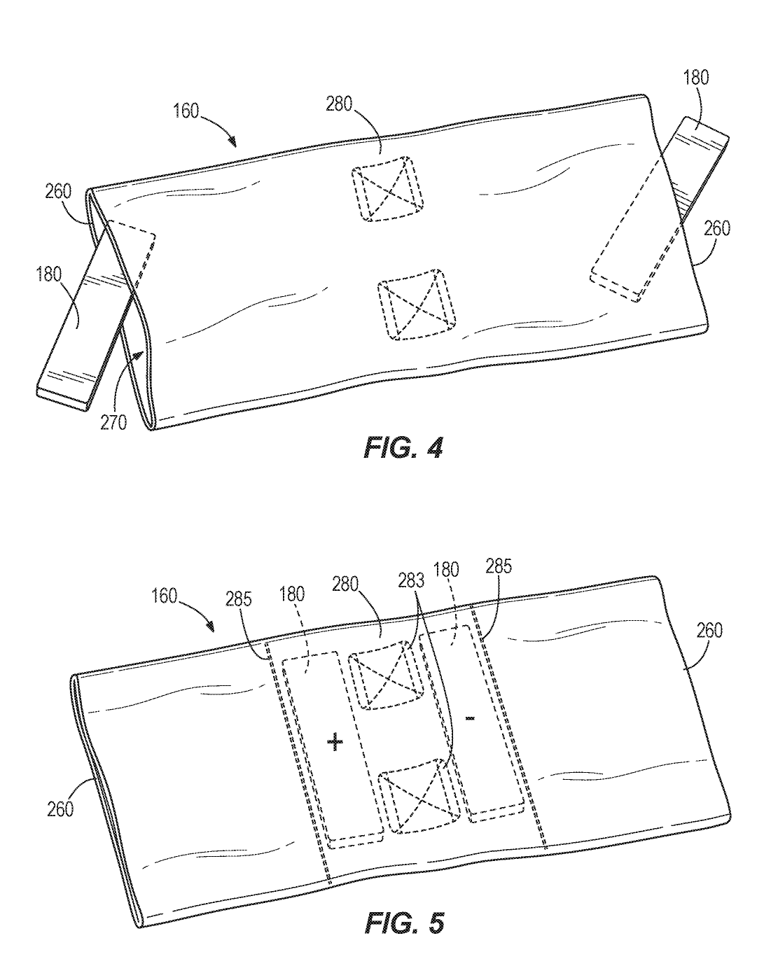

Referring now to FIGS. 4 and 5, the sleeves 160 are made of a tough, flexible fabric such as CORDURA brand fabric. Each sleeve 160 includes openings 260 at both ends and an interior space 270. In a middle portion 280 of the sleeve 160, the sides are sewn together with center stitching 283 to divide the interior space 270 into two sides. In the illustrated embodiment a magnet 180 is inserted into the interior space 270 through the opening 260 at each end of the sleeve 160. The sleeve walls are then sewn together with capture stitching 285 adjacent to the outward edge (i.e., the edge closest to the open ends 260) of the magnets 180. With this assembly, the magnets 180 are captured between the center stitching 283 and capture stitching 285 to separate the magnets 180 and prevent the magnets 180 from flipping so that the magnetic poles are maintained in the desired orientation. It should be noted that means and methods other than or in addition to stitching can be used for sealing the sleeve 160, such as heat, glue, rivets, clips, clamps, or staples to achieve the same or similar results and such other means and methods are within the scope of this invention and generically referred to as “sealing structure.” With reference back to FIGS. 2 and 3, the center stitching 283 defines the width of the middle portion 280, such that the middle portion 280 is of a sufficient width to wrap over the strap-attaching portion 220 of the end piece 140 and position the magnets 180 flat against the flat sides of the strap-attaching portion 220.

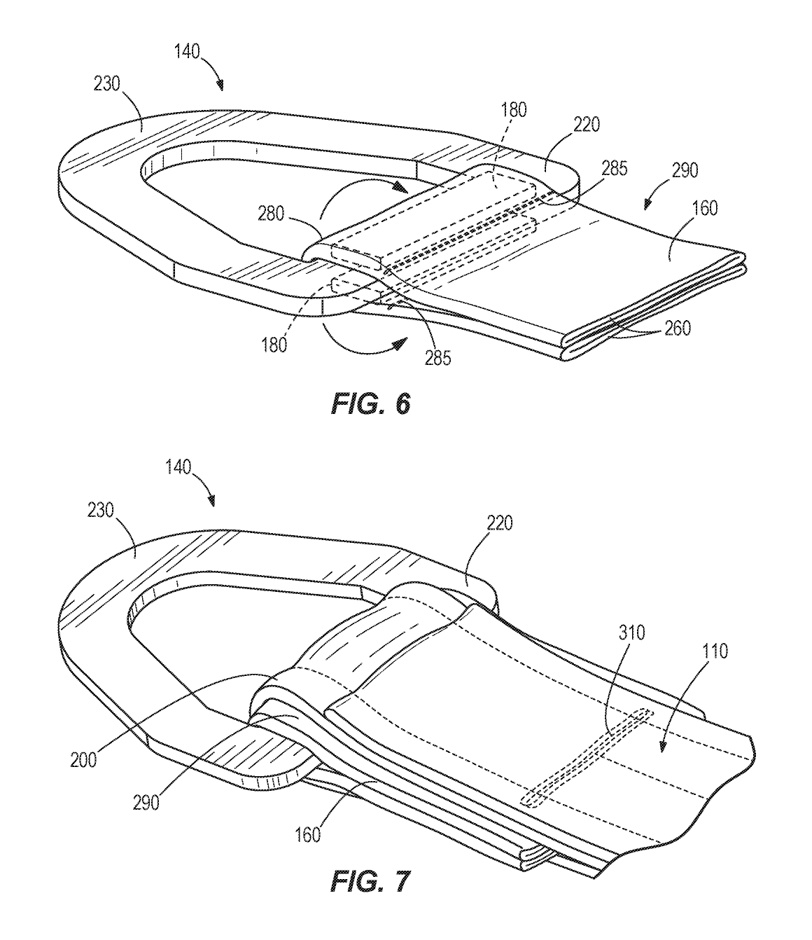

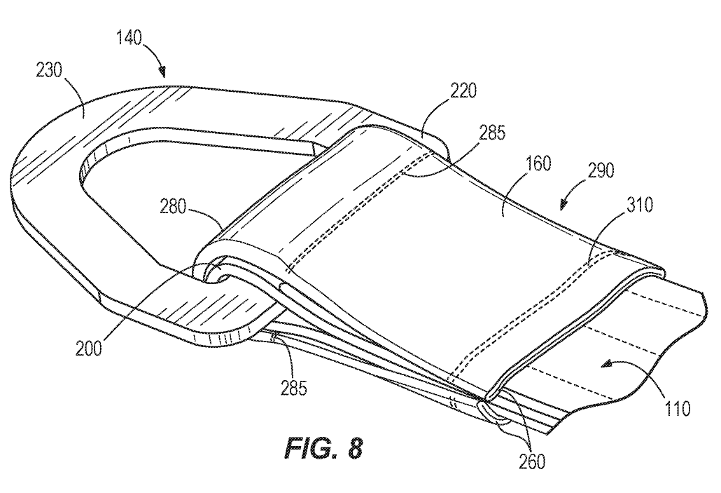

Referring to FIGS. 6 and 7, the sleeve 160 is formed into a sleeve loop 290 by folding or looping the sleeve 160 at its middle portion 280 over the strap-attaching portion 220 of the associated end piece 140. The strap loop 200 is formed over the sleeve loop 290, and the strap loop 200 and sleeve loop 290 are secured to the strap attaching portion 220 of the end piece 140 with a loop-securing mechanism. In the illustrated embodiment, the loop-securing mechanism consists of stitching 310 through both the strap loop 200 and sleeve loop 290 in a single process such that the strap loop 200 and sleeve loop 290 are simultaneously closed and secured to each other around the end piece 140. In other embodiments, one or both of the strap loop 200 and sleeve loop 290 may be stitched independently of each other. In other embodiments, one or both of the strap loop 200 and sleeve loop 290 may be secured with another type of loop-securing mechanism such as a clamp, rivets, staples or substantially any other suitable mechanical fastening device. In other embodiments, the sleeve loop 290 may be outside the strap loop 200 (as illustrated in FIG. 8) or between layers of the strap 110 within the strap loop 200.

The interior space 270 is closed by the loop-securing mechanism, such that the magnets 180 are captured or trapped within the interior space 270 of the sleeve 160. More specifically, the magnets 180 are positioned adjacent the strap-attaching portion 220 of the end piece 140 in the illustrated embodiment. As seen in FIGS. 2 and 3, the magnets 180 are inserted such that on one side of the end piece 140 the positive pole of one magnet 180 faces out and on the other side of the end piece 140 the negative pole of the other magnet 180 faces out. The magnets 180 are configured such that opposite poles are provided at the opposite ends of the same side of the axle strap assembly 100.

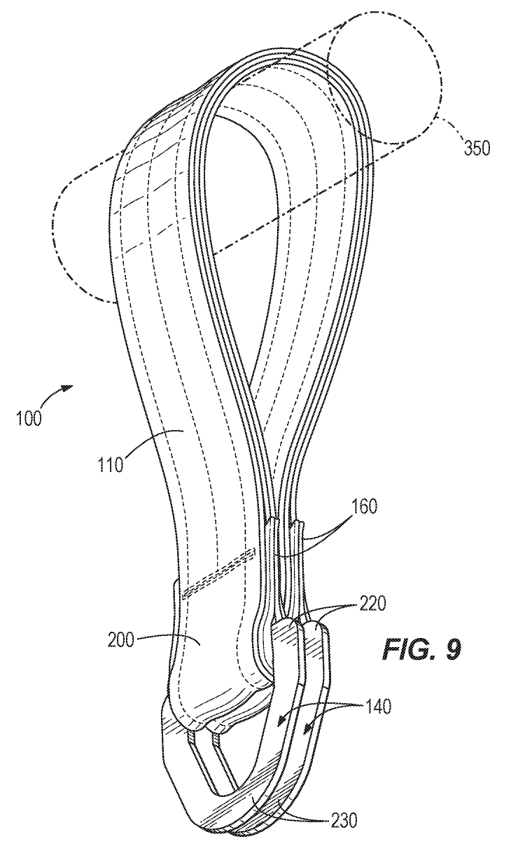

FIG. 9 illustrates the axle strap assembly 100 installed on an axle 350. The strap 110 is wrapped around the axle 350 and the end pieces 140 are brought together. The magnets 180 attract each other and hold the end pieces 140 together while an axle-securing device is attached to the axle-securing portions 230 of the end pieces. The magnet sleeves 160 hold the magnets 180 in position during operation. The sleeves 160 obviate the use of glue or other adhesive between the magnets 180 and strap-attaching portions 220 of the end pieces 140.

In other embodiments, a magnet 180 may be captured adjacent one of the end pieces 140 in a magnet sleeve 160 and the other end piece 140 may be made of a ferromagnetic material that is attracted to the magnet 180. Whether there is a magnet at both end pieces or just one, the end pieces are magnetically attracted to each other.

Thus, the invention provides, among other things, an axle strap assembly that includes magnet sleeves on the end pieces to hold the magnets in place during use. Various features and advantages of the invention are set forth in the following claims.

What is claimed is:

1. An axle strap assembly comprising:
an end piece;
a strap folded over a portion of the end piece;
a magnet;
a sleeve surrounding the magnet and folded over the end piece;
a loop-securing mechanism securing the sleeve to the end piece and trapping the magnet in the sleeve.

2. The axle strap assembly of claim 1, wherein the end piece is a first end piece at a first end of the strap, the assembly further comprising a second end piece at a second end of the strap, the first and second end pieces being magnetically attracted to each other.

3. The axle strap assembly of claim 2, wherein the magnet, sleeve, and loop-securing mechanism are a respective first magnet, first sleeve, and first loop-securing mechanism; the assembly further comprising a second magnet, a second sleeve, and a second loop-securing mechanism; the second magnet being within the second sleeve; and the second loop-securing mechanism securing the second sleeve to the second end piece and trapping the second magnet in the second sleeve.

4. The axle strap assembly of claim 1, wherein the strap and sleeve are folded over the same portion of the end piece in overlapping fashion.

5. The axle strap assembly of claim 1, wherein the strap is folded over the sleeve on the end piece.

6. The axle strap assembly of claim 1, wherein the sleeve is folded over at least a portion of the strap on the end piece.

7. The axle strap assembly of claim 1, wherein the loop-securing mechanism secures both the sleeve and the strap to the end piece.

8. The axle strap assembly of claim 1, wherein the loop-securing mechanism includes stitching.

9. The axle strap assembly of claim 1, further comprising a sealing structure applied to the sleeve to capture the magnet within the sleeve, the sealing structure being separate from the loop-securing mechanism.

10. An axle strap assembly comprising:
a first end piece having a strap-attaching portion and an axle-securing portion;
a second end piece having a strap-attaching portion and an axle-securing portion;
a strap defining a first strap loop folded over the strap-attaching portion of the first end piece and a second strap loop folded over the strap-attaching portion of the second end piece;
a first sleeve having an interior space and defining a first sleeve loop folded over the strap-attaching portion of the first end piece;
a second sleeve having an interior space and defining a second sleeve loop folded over the strap-attaching portion of the second end piece;
a first magnet within the interior space of the first sleeve;
a second magnet within the interior space of the second sleeve;
a first loop-securing mechanism closing the first strap loop and the first sleeve loop over the strap-attaching portion of the first end piece to secure the strap to the first end piece and to trap the first magnet within the interior space of the first sleeve; and
a second loop-securing mechanism closing the second strap loop and the second sleeve loop over the strap-attaching portion of the second end piece to secure the strap to the second end piece and to trap the second magnet within the interior space of the second sleeve;
wherein the first and second magnets attract each other to align the axle-securing portions of the first and second end pieces to facilitate attachment of an axle-securing device to the first and second end pieces.

11. The axle strap assembly of claim 10, wherein the first and second end pieces are delta rings.

12. The axle strap assembly of claim 10, wherein axle-attaching portions of the first and second end pieces are configured to receive a hook type axle-securing device.

13. The axle strap assembly of claim 10, wherein the first and second sleeve loops are within the respective first and second strap loops.

14. The axle strap assembly of claim 10, wherein the first and second strap loops are within the respective first and second sleeve loops.

15. The axle strap assembly of claim 10, further comprising:
a third magnet within the interior space of the first sleeve, the third magnet being secured on a side of the first end piece opposite the first magnet and trapped in the interior space of the first sleeve by the first loop-securing mechanism; and
a fourth magnet within the interior space of the second sleeve, the fourth magnet being secured on a side of the second end piece opposite the second magnet and trapped in the interior space of the second sleeve by the second loop-securing mechanism;
wherein the third and fourth magnets attract each other to align the axle-securing portions of the first and second end pieces to facilitate attachment of an axle-securing device to the first and second end pieces.

16. The axle strap assembly of claim 10, wherein the first loop-securing mechanism includes stitching.

17. The axle strap assembly of claim 16, wherein the stitching extends through both the first strap loop and the first sleeve loop such that the first strap loop and first sleeve looped are stitched closed while simultaneously being stitched to each other.

18. The axle strap assembly of claim 10, wherein the first magnet is trapped adjacent the strap-attaching portion of the first end piece and the second magnet is trapped adjacent the strap-attaching portion of the second end piece.

19. The axle strap assembly of claim 10, further comprising a first sealing structure applied to the first sleeve to capture the first magnet within the first sleeve; and a second sealing structure applied to the second sleeve to capture the second magnet within the second sleeve; the first and second sealing structures being separate from the first and second loop-securing mechanisms.

20. A method of assembling an axle strap assembly having a strap, an end piece, a sleeve, and a magnet, the method comprising:
inserting the magnet into the sleeve;
folding the sleeve over the end piece;
folding the strap over the end piece; and
applying a loop-securing mechanism to the sleeve to secure the sleeve to the end piece and capture the magnet in the sleeve.

21. The method of claim 20, wherein the end piece is a first end piece at a first end of the strap, the method further comprising: providing a second end piece that is magnetically attracted to the first end piece; and folding the strap over the second end piece at a second end of the strap.

22. The method of claim 21, wherein the magnet, sleeve, and loop-securing mechanism are a respective first magnet, first sleeve, and first loop-securing mechanism; the method further comprising: inserting a second magnet into a second sleeve; folding a second sleeve over the second end piece; folding the strap over the second end piece; and applying a second loop-securing mechanism to the second sleeve to secure the second sleeve to the second end piece and capture the second magnet in the second sleeve

23. The method of claim 20, wherein folding the strap and folding the sleeve are done in overlapping fashion.

24. The method of claim 20, wherein applying a loop-securing mechanism includes securing both the sleeve and the strap to the end piece.

25. The method of claim 20, wherein applying a loop-securing mechanism includes stitching the sleeve.

26. The method of claim 20, further comprising applying a sealing structure, independent of the loop-securing mechanism, to the sleeve to capture the magnet within the sleeve.
